(19) United States
(12) Patent Application Publication
(10) Pub. No.: US 2024/0359348 A1
(43) Pub. Date: Oct. 31, 2024

(54) SENSOR-BASED SYSTEMS AND METHODS OF ANALYZING SHAVING PERFORMANCE

(71) Applicant: The Gillette Company LLC, Boston, MA (US)

(72) Inventors: Andrea Plat, Boston, MA (US); Ian Anthony Good, Reading (GB); Shirley Namubiru, Reading (GB); Grace Marie Keeton, Reading (GB)

(21) Appl. No.: 18/308,998

(22) Filed: Apr. 28, 2023

(51) Int. Cl. B26B 21/40; B26B 21/54

(52) U.S. Cl. CPC B26B 21/4093; B26B 21/4031; B26B 21/54

(57) ABSTRACT

Sensor-based systems and methods of analyzing shaving performance. A shaving device comprises a handle having a connecting structure connected to a hair-cutting implement (e.g., a blade). Sensor data is collected from sensor(s) associated with the shaving device during one or more shaving strokes of a user shaving with the shaving device. Shave stroke data is determined from the sensor data that defines one or more shaving strokes. The shave stroke data and a threshold value is input into a model (e.g., an artificial intelligence model) to output a user-specific shave score. Generation of the user-specific shave score comprises comparing the shave stroke data to the threshold value to determine a deviation from the threshold value. An output is generated based on the user-specific shave score.

### FIELD

The present disclosure generally relates to sensor-based systems and methods, and more particularly to, sensor-based systems and methods of analyzing shaving performance.

### BACKGROUND

Generally, shave performance can be summarized as a trade-off between closeness and irritation, where an individual typically can either achieve, on the one hand, an increased closeness of shave (removing more hair) but risking irritation or redness of his or her skin, or, on the other hand, a less close shave (leaving more hair) but reducing the risk of skin irritation. Individuals typically try to balance this trade-off to get their desired end result by manually regulating the quantity, direction and pressure (or load) of strokes applied during a shave. Taking an increased quantity of strokes, taking strokes going against the direction of hair growth or applying increased pressure during strokes will typically result in both increased closeness and increased risk of skin irritation. However, there is typically a point of shave pressure that once breached yields minimal increase closeness benefit while yielding a high risk of unwanted skin irritation.

Thus a problem arises for existing shaving razors, and the use thereof, where individuals desiring a close shave generally apply too many strokes, too many strokes going against the hair growth direction and/or too much pressure (or load) during a shave session, under the false impression that it will improve the closeness of the end result. The problem is acutely pronounced given the various versions, brands, and types of shaving razors currently available to individuals, where each of the versions, brands, and types of shaving razors have different components, blades, sharpness, and/or otherwise different configurations, all of which can vary significantly in the quantity, direction and pressure (or load) of strokes required, and for each shaving razor type, to achieve a close shave (e.g., with little or no hair remaining) with little or no skin irritation. This problem is particularly acute because such existing shaving razors-, which may be differently configured—provide little or no feedback or guidance to assist the individual achieve a close shave without skin irritation.

For the foregoing reasons, there is a need for sensor-based systems and methods of analyzing shaving performance.

### SUMMARY

Sensor-based shaving systems and methods are described herein regarding analyzing shaving performance. Generally, the sensor-based shaving systems and methods comprise a shaving device (e.g., a shaving razor such as a wet shave razor). The shaving device can include a handle and a connecting structure for connecting a hair-cutting implement (e.g., a razor blade). The shaving device can also comprise, or be associated with, a shave event sensor (e.g., a load sensor) to collect shaving data of a user. Live feedback and/or indicators may be provided the user via an indication, e.g., green light-emitting diode (LED) feedback when the user is applying pressure within or below a unique threshold value, or a red LED feedback when the user is applying pressure above the unique threshold value of the user.

Reducing skin irritation may be determined by various factors, including, for example, the user's shave behavior and the wear on a cartridge (e.g., a razor blade). Other external factors may also be determinative, such as the presence of shave preparation and/or environmental conditions (e.g., wet or dry shaving). Such factors can be measured electronically by sensors associated with a shaving device and/or reported as data as supplied by the user, e.g., via a display screen. The sensor and/or user-supplied data can be input into smart algorithms, such as an artificial intelligence model and/or other model, to output a user-specific shave score that may be displayed to the user. A user may monitor, track, or otherwise use the output and feedback (e.g., a user-specific shave score) to modify his or her behavior and seek to improve his or her user-specific shave score, resulting less real-world skin irritation, such then better shave experience or performance.

Indication and/or load feedback features, as provided by the sensor-based systems and methods, warn users to deter behavior that causes skin irritation, and encourages behavior that reduces skin irritation. For this reason, analysis of a load threshold of a user (e.g., a unique threshold value) to determine deviation from the threshold value during a shave stroke can allow the user to prevent skin damage. For example, a vast majority of user shave strokes typically lies within the range of 50 gram-force (gf) to 500 gf, and the average peak load during a shave stroke is approximately in the range of 200 gf to 250 gf. Based on this data, a load threshold value of a user (e.g., a unique threshold value), for example 250 gf, can be set or determined for a shaving device of the user, e.g., at least as an initial target value, to encourage a user to change his or her behavior to bring his or her specific load or pressure (as applied to his or her skin or face) to within a lower half of the typical load range, or at least within a deviation to reduce skin irritation. Reduction of load or pressure to a user's skin or face provides an irritation benefit, and at a specific user level using the unique threshold value, which may be specific to each user, as described herein.

Generally, in various embodiments, unique, specific, and/or personalized threshold values, as used, stored, and/or implemented by a shaving device as described herein, may be generated and/or used to provide corresponding specific users with unique, specific, and/or personalized shaving feedback and performance for the purpose of reducing skin irritation.

More specifically, in accordance with various embodiments herein, a sensor-based method is disclosed for analyzing shaving performance. The sensor-based method may comprise collecting, by one or more processors, sensor data from one or more sensors of a shaving device having a blade, the sensor data collected during one or more shaving strokes of a user shaving with the shaving device. The sensor-based method may further comprise determining, based on the sensor data, shave stroke data defining the one or more shaving strokes. The sensor-based method may further comprise inputting, into a model executing on the one or more processors, the shave stroke data and a threshold value to output a user-specific shave score. Generation of the user-specific shave score may comprise comparing the shave stroke data to the threshold value to determine a deviation from the threshold value. The sensor-based method may further comprise generating an output based on the user-specific shave score.

In additional embodiments, as described herein, a sensor-based system is configured to analyze shaving performance. The sensor-based system comprises a shaving device having a blade and comprising one or more sensors. The sensor-based system further comprises one or more processors communicatively coupled to the shaving device. The sensor-based system further comprises a memory communicatively coupled to the one or more processors. The sensor-based system further comprises a model configured to execute on the one or more processors. The sensor-based system further comprises computing instructions stored on the memory and that, when executed by the one or more processors, cause the one or more processors to collect sensor data from the one or more sensors of the shaving device. The sensor data may be collected during one or more shaving strokes of a user shaving with the shaving device. The computing instructions may further be executed by the one or more processors to determine, based on the sensor data, shave stroke data defining the one or more shaving strokes. The computing instructions may further be executed by the one or more processors to input, into the model, the shave stroke data and a threshold value to output a user-specific shave score. The generation of the user-specific shave score may comprise comparing the shave stroke data to the threshold value to determine a deviation from the threshold value. The computing instructions may further be executed by the one or more processors to generate an output based on the user-specific shave score.

In still further embodiments, a non-transitory computer-readable medium storing computing instructions that when executed by one or more processors for analyzing shaving performance is disclosed. The computing instructions, when executed by the one or more processors, may cause the one or more processors to collect sensor data from one or more sensors of a shaving device having a blade, the sensor data collected during one or more shaving strokes of a user shaving with the shaving device. The computing instructions, when executed by the one or more processors, may further cause the one or more processors to determine, based on the sensor data, shave stroke data defining the one or more shaving strokes. The computing instructions, when executed by the one or more processors, may further cause the one or more processors to input, into a model executing on the one or more processors, the shave stroke data and a threshold value to output a user-specific shave score. The generation of the user-specific shave score may comprise comparing the shave stroke data to the threshold value to determine a deviation from the threshold value. The computing instructions, when executed by the one or more processors, may further cause the one or more processors to generate an output based on the user-specific shave score.

In accordance with the above, and with the disclosure herein, the present disclosure includes improvements in computer functionality or in improvements to other technologies at least because the disclosure describes that, e.g., in some embodiments, a shaving device and/or a server to which the shaving device is communicatively connected, is improved where the intelligence or predictive ability of the shaving device and/or server is enhanced by a trained model, e.g., a sensor-based learning model, which may comprise a machine learning model. In such embodiments, the model, executing on the server and/or at the shaving device, is able to accurately identify, based on sensor data from one or more sensors of a shaving device, a user-specific shave score, which defines the user's real-world shave performance. That is, the present disclosure, with respect to some embodiments, describes improvements in the functioning of the computer itself or “any other technology or technical field” because the shaving device, and/or the server to which it is communicatively connected, is enhanced with a sensor-based learning model to accurately predict, detect, or determine unique user-specific shave scores of various users. This improves over the prior art at least because existing systems lack such predictive or classification functionality and are simply not capable of accurately analyzing sensor data and/or datasets of a specific user to determine a unique user-specific shave scores that is designed for implementation on a shaving device to provide an output specific to the user's real-world activity. The predictive output, as provided by the model, may improve the underlying device, e.g., a shaving device, by virtue of causing the cartridge or blade of the shaving device to receive maintenance and/or replacement, thereby improving the real-world operation and longevity of the shaving device.

For similar reasons, the present disclosure relates to improvement to other technologies or technical fields at least because the present disclosure describes or introduces improvements to computing devices in the field of shaving devices (e.g., shaving razors), whereby a shaving device, as described herein, is updated and enhanced with a model, whether onboard the shaving device or via communication with a server, to detect and track a user's real-world use of the device.

In addition, the present disclosure includes applying certain of the claim elements with, or by use of, a particular machine, e.g., a shaving device having a hair-cutting implement (e.g., a blade). The shaving device comprises sensors for collecting sensor data during one or more shaving strokes of a user shaving with the shaving device.

In addition, the present disclosure includes specific features other than what is well-understood, routine, conventional activity in the field, or adding unconventional steps that confine the claim to a particular useful application, e.g., analyzing shaving performance as described herein.

Advantages will become more apparent to those of ordinary skill in the art from the following description of the preferred embodiments, which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the system and methods disclosed therein. It should be understood that each Figure depicts an embodiment of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and instrumentalities shown, wherein:

FIG. 1 illustrates an example sensor-based system configured to analyze shaving performance in accordance with various embodiments disclosed herein.

FIG. 2 illustrates a further example of a sensor-based system, having multiple shaving devices, and configured to analyze shaving performance for respective users in accordance with various embodiments disclosed herein.

FIG. 3 illustrates a flowchart or algorithm of an example sensor-based method of analyzing shaving performance in accordance with various embodiments disclosed herein.

FIG. 4A is a table defining example input(s) of a model for determination or output of a user-specific shave score in accordance with various embodiments disclosed herein.

FIG. 4B is a further table defining further example input(s) of a model for determination or output of a user-specific shave score in accordance with various embodiments disclosed herein.

FIG. 5 is a table defining example metrics, inputs, and data sources that may be used by a model (e.g., an artificial intelligence model) for outputting a user-specific shave score in accordance with various embodiments disclosed herein.

FIG. 6 illustrates an example of a user shaving with the shaving device as described for FIGS. 1 and 2 in accordance with various embodiments disclosed herein.

FIG. 7 illustrates an example user interface as rendered on a display screen of a user computing device in accordance with various embodiments disclosed herein.

The Figures depict preferred embodiments for purposes of illustration only. Alternative embodiments of the systems and methods illustrated herein may be employed without departing from the principles of the invention described herein.

### DETAILED DESCRIPTION OF THE INVENTION

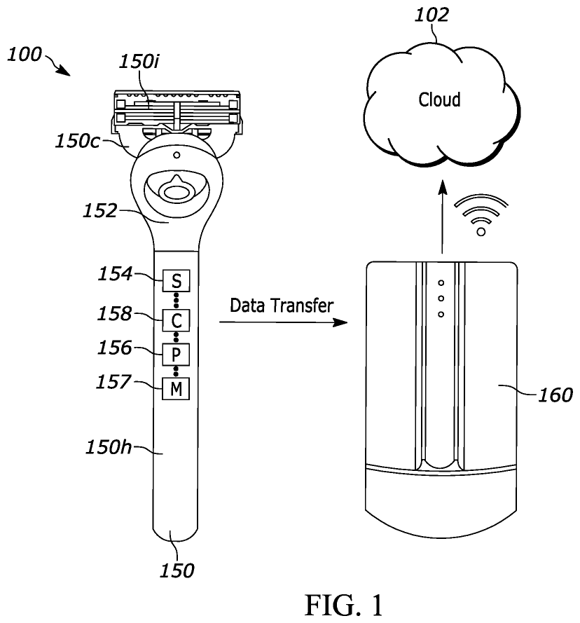

FIG. 1 illustrates an example sensor-based system 100 configured to analyze shaving performance in accordance with various embodiments disclosed herein. As shown in the embodiment of FIG. 1, sensor-based shaving system 100 comprises a shaving device 150 (e.g., a grooming device) having (i) a handle 150h comprising a connecting structure 150c, and (ii) a hair cutting implement 150i connected to the connecting structure 150c. In the embodiment of embodiment of FIG. 1, shaving device 150 is illustrated as a shaving razor with a detachable hair-cutting implement 150i (e.g., a razor blade or cartridge). A shaving device, as described herein, may comprise other similar shaving devices, including, for example, but not limited to at least one of an electric shaver, a shaving razor, or an epilator.

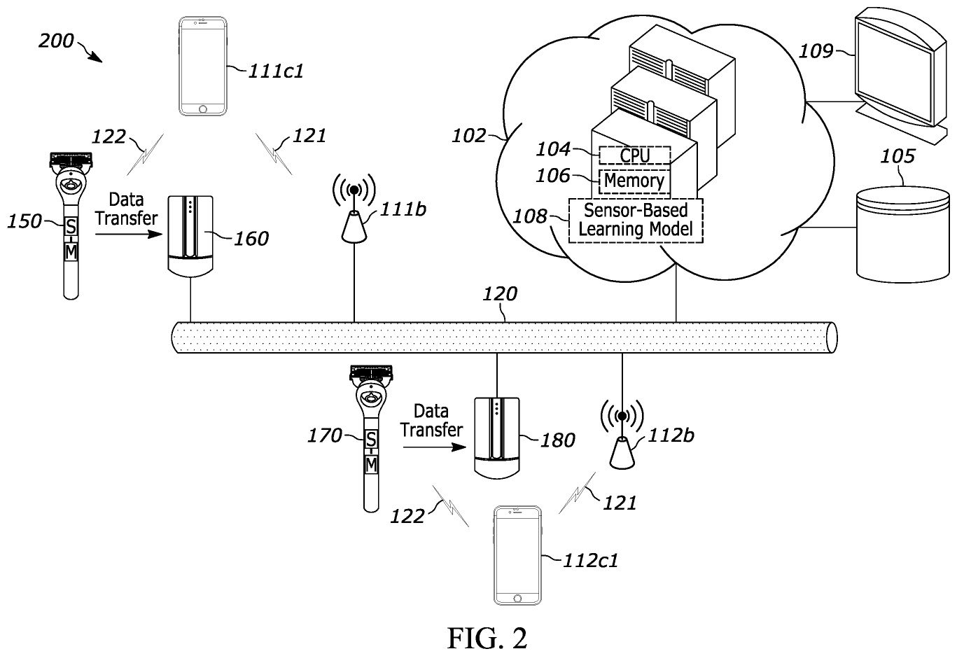

Sensor-based shaving system 100 further comprises a shave event sensor 154 (e.g., a load sensor) configured to collect sensor data and, as a result, measure user behavior associated with a shave event of a user. Shave event sensor 154 may comprise one or more of a displacement sensor, a load sensor, a movement sensor, an optical sensor, an audio sensor, and/or a temperature sensor. In the embodiment of FIG. 1, shave event sensor 154 is communicatively coupled to shaving device 150, where shave event sensor 154 is positioned on shaving device 150. In other embodiments, shave event sensor 154 may be communicatively coupled, e.g., via wired or wireless communication, to a charging station (not shown) of a shaving device (e.g., shaving device 150), a cradle (not shown) for holding or receiving the shaving device (e.g., shaving device 150), or a computing device having a processor (e.g., user computing device 111c1 as illustrated in FIG. 2 herein) executing a digital app.

Sensor-based shaving system 100 further comprises a transceiver 158. In various embodiments, the transceiver 158 may be a wired or wireless transceiver positioned on or within shaving device 150. The transceiver 158 may comprise any one or more of a wired connection or a wireless connection, such as a Bluetooth connection, a Wi-Fi connection, a cellular connection and/or an infrared connection. In various embodiments, the transceiver 158 is communicatively coupled to the shaving device, a charging station (not shown) of the shaving device, cradle (not shown) for holding or receiving the shaving device (e.g., shaving device 150), or a computing device having a processor (e.g., user computing device 111c1 as illustrated in FIG. 2 herein) executing a digital application (app).

Sensor-based shaving system 100 further comprises a processor 156 (e.g., a microprocessor) and is communicatively coupled, e.g., via a computing bus or printed circuit board (PCB), to shave event sensor 154 and the transceiver 158. Processor 156 is configured to receive, transmit, and analyze data (e.g., shave data) as provided from shave event sensor 154 and/or the transceiver 158. In various embodiments, processor 156 is configured to execute computing instructions stored on a memory 157 (e.g. of shaving device 150) communicatively coupled to processor 156. The instructions may cause processor 156 to collect data from the shave event sensor. The data may comprise shave data defining a shave event, e.g., such as one or more shaving strokes of a user shaving with the shaving device.

In the embodiment of FIG. 1, processor 156 is illustrated as on-board shaving device 150. For example, in some embodiments, generation of the user-specific shave score, may be implemented by an onboard processor onboard the shaving device (e.g., shaving device 150). For example, in some aspects, a model (e.g., an artificial intelligence model) may be stored in memory 157 and configured to execute on processor 156. Computing instructions stored on memory 157 that, when executed by processor 156, may cause processor 156 to collect sensor data from sensor 154 during one or more shaving strokes of a user shaving with the shaving device 150. The processor 156 may determine, based on the sensor data, shave stroke data defining the one or more shaving strokes. The shave stroke data and a threshold value may be input into model to output a user-specific shave score. Generation of the user-specific shave score may comprise comparing the shave stroke data to the threshold value to determine a deviation from the threshold value. The processor 156, executing the model stored in memory 157, may generate an output based on the user-specific shave score. The output may be a display value or a value sent to a computer network and/or server as described herein.

Additionally, or alternatively, processor 156 may be located off board the shaving device. For example, processor 156 may be located on a cradle, charging station to which shaving device 150 connects. Still further, in some aspects, processor 156 may comprise a processor of a user computing device (e.g., user computing device 111c1). In addition aspects, the user-specific shave score, may be implemented by an off board processor (e.g., a processor of server(s) 102 as described for FIG. 2 herein) communicatively coupled to the shaving device (e.g., shaving device 150) via a wired or wireless computer network. Still further, in some embodiments, the off-board processor may be configured to execute as part of one or more processors comprising at least one of a base station of the shaving device (e.g., shaving device 150), a mobile device (e.g., user computing device 111c1 as illustrated in FIG. 2 herein), or a remote computing device (e.g., server(s) 102, which may be cloud based servers a described herein). In such embodiments, shaving device 150 may transmit and/or receive, e.g., via its transceiver 158 and/or processor, sensor data, shave data and/or datasets to a computer network device 160, e.g., which may be a router, Wi-Fi router, hub, or switch, capable of sending and receiving data on a computer network, e.g., to server(s) 102 as described for FIG. 2 herein.

FIG. 2 illustrates a further example of a sensor-based system 200, having multiple shaving devices, and configured to analyze shaving performance for respective users in accordance with various embodiments disclosed herein. For example, in the embodiment of FIG. 2, sensor-based system 200 includes shaving device 150 as described for FIG. 1. Sensor-based system 200 further includes a second shaving device 170. Shaving device 170 is configured the same or similarly as described herein for FIG. 1. For example, shaving device 170 is configured to communicatively coupled to a computer network device 180, e.g., which may be a router, Wi-Fi router, hub, or switch, cable of sending and receiving packet data on a computer network (e.g., computer network 120), e.g., to server(s) 102 as shown for FIG. 2.

In the example embodiment of FIG. 2, sensor-based system 200 includes server(s) 102, which may comprise one or more computer servers. In various embodiments, server(s) 102 comprise multiple servers, which may comprise multiple, redundant, or replicated servers as part of a server farm. In still further embodiments, server(s) 102 may be implemented as cloud-based servers, such as a cloud-based computing platform. For example, server(s) 102 may be any one or more cloud-based platform(s) such as MICROSOFT AZURE, AMAZON AWS, or the like. Server(s) 102 may include one or more processor(s) 104 as well as one or more computer memories 106.

Memorie(s) 106 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memorie(s) 106 may store an operating system (OS) (e.g., Microsoft Windows, Linux, UNIX, etc.) capable of facilitating the functionalities, apps, methods, or other software as discussed herein. The memorie(s) 106 may also store a model 108 (e.g., a sensor-based learning), which may be an artificial intelligence based model, such as a machine learning model, trained on shave data or datasets, or otherwise a model as described herein. Additionally, or alternatively, model 108 may also be stored in database 105, which is accessible or otherwise communicatively coupled to server(s) 102. The memories 106 may also store machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosures herein. For example, at least some of the applications, software components, or APIs may be, include, otherwise be part of, an imaging-based machine learning model or component, such as model 108, where each may be configured to facilitate their various functionalities discussed herein. It should be appreciated that one or more other applications may be envisioned and that are executed by the processor(s) 104.

The processor(s) 104 may be connected to the memories 106 via a computer bus responsible for transmitting electronic data, data packets, or otherwise electronic signals to and from the processor(s) 104 and memories 106 in order to implement or perform the machine readable instructions, methods, processes, elements or limitations, as illustrated, depicted, or described for the various flowcharts, illustrations, diagrams, figures, and/or other disclosures herein.

The processor(s) 104 may interface with the memory 106 via the computer bus to execute the operating system (OS). The processor(s) 104 may also interface with the memory 106 via the computer bus to create, read, update, delete, or otherwise access or interact with the data stored in the memories 106 and/or the database 105 (e.g., a relational database, such as Oracle, DB2, MySQL, or a NoSQL based database, such as MongoDB). The data stored in the memories 106 and/or the database 105 may include all or part of any of the data or information described herein, including, for example, sensor data, shave data, and/or or datasets (e.g., first or subsequent datasets regarding sensor and/or shave data) or other information of the user, user profile data including demographic, age, race, skin type, or the like, and/or previous shave data associated with one or more shaving devices or implements. For example, in some embodiments, user profile data may be obtained via a questionnaire or display form in a software app associated with the shaving device 150, e.g., shave event data as reported by the user via a user computer device 111c1.

In some aspects, data (e.g., such as sensor data or user data) may be collected from multiple shaving devices (e.g., shaving device 150 and shaving device 170). Such data may be used to train model 108, which may be stored on memory 106 and/or downloaded to shaving device 150 for storage on memory 157 and/or execution by processor 156.

With reference to FIG. 2, server(s) 102 may further include a transceiver configured to communicate (e.g., send and receive) data via one or more external/network port(s) to one or more networks or local terminals, such as computer network 120 and/or terminal 109 (for rendering or visualizing) described herein. In some embodiments, server(s) 102 may include a client-server platform technology such as ASP.NET. Java J2EE, Ruby on Rails, Node.js, a web service or online API, responsive for receiving and responding to electronic requests. The server(s) 102 may implement the client-server platform technology that may interact, via the computer bus, with the memories(s) 106 (including the applications(s), component(s), API(s), data, etc. stored therein) and/or database 105 to implement or perform the machine readable instructions, methods, processes, elements or limitations, as illustrated, depicted, or described for the various flowcharts, illustrations, diagrams, figures, and/or other disclosure herein.

According to some embodiments, the server(s) 102 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to computer network 120. In some embodiments, computer network 120 may comprise a private network or local area network (LAN). Additionally, or alternatively, computer network 120 may comprise a public network such as the Internet.

Server(s) 102 may further include or implement an operator interface configured to present information to an administrator or operator and/or receive inputs from the administrator or operator. As shown in FIG. 2, an operator interface may provide a display screen (e.g., via terminal 109). Server(s) 102 may also provide I/O components (e.g., ports, capacitive or resistive touch sensitive input panels, keys, buttons, lights, LEDs), which may be directly accessible via or attached to server(s) 102 or may be indirectly accessible via or attached to terminal 109. According to some embodiments, an administrator or operator may access the server 102 via terminal 109 to review information, make changes, input training data, and/or perform other functions.

As described above herein, in some embodiments, server(s) 102 may perform the functionalities as discussed herein as part of a “cloud” network or may otherwise communicate with other hardware or software components within the cloud to send, retrieve, or otherwise analyze data or information described herein.

In general, a computer program or computer based product, application, or code (e.g., the model(s), such as an artificial model (e.g., sensor-based learning model 108), or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor(s) 104 (e.g., working in connection with the respective operating system in memories 106) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang. Python, C, C++, C#, Objective-C, Java, Scala, ActionScript, JavaScript, HTML, CSS, XML, etc.).

As shown in FIG. 2, server(s) 102 are communicatively connected, via computer network 120 to shaving device 150 and shaving device 170. Each of shaving device 150 and shaving device 170 may connect to their computer network devices 160 180, respectively, as described herein, e.g., which may be a router, Wi-Fi router, hub, or switch, capable of sending and receiving packet data on a computer network (e.g., computer network 120), e.g., to server(s) 102. In particular, computer network devices 160 and 180 may comprise routers, wireless switches, or other such wireless connection points communicating with user computing devices (e.g., user computing device 111c1 and user computing device 112c1) via wireless communications 122 based on any one or more of various wireless standards, including by non-limiting example, IEEE 802.11a/b/c/g (WIFI), the BLUETOOTH standard, or the like.

Server(s) 102 are also communicatively connected, via computer network 120, to user computing devices, including user computing device 111c1 and user computing device 112cl, via base stations 111b and 112b. Base stations 111b and 112b may comprise cellular base stations, such as cell towers, communicating to user computing devices (e.g., user computing device 111c1 and user computing device 112c1), via wireless communications 121 based on any one or more of various mobile phone standards, including NMT, GSM, CDMA, UMMTS, LTE, 5G, or the like.

User computing devices, including user computing device 111c1 and user computing device 112cl may connect to shaving device 150 and shaving device 170 either directly or via computer network devices 160 and 180. Additionally, or alternatively, shaving device 150 and shaving device 170 may connect to server(s) 102 over computer network 120 via either base stations 111b or 112b and/or computer network devices 160 and 180.

User computing devices (e.g., user computing device 111c1 and user computing device 112c1) may comprise mobile devices and/or client devices for accessing and/or communications with server(s) 102. In various embodiments, user computing devices (e.g., user computing device 111c1 and user computing device 112c1) may comprise a cellular phone, a mobile phone, a tablet device, a personal data assistance (PDA), or the like, including, by non-limiting example, an APPLE iPhone or iPad device or a GOOGLE ANDROID based mobile phone or table. In addition, the user computing devices (e.g., user computing device 111c1 and user computing device 112c1) may implement or execute an operating system (OS) or mobile platform such as Apple's iOS and/or Google's Android operating system. Any of the user computing devices (e.g., user computing device 111c1 and user computing device 112c1) may comprise one or more processors and/or one or more memories for storing, implementing, or executing computing instructions or code, e.g., a mobile application, as described in various embodiments herein.

User computing devices (e.g., user computing device 111c1 and user computing device 112c1) may comprise a wireless transceiver to receive and transmit wireless communications 121 and/or 122 to and from base stations 111b and/or 112b. In this way, data (e.g., such as sensor and/or user data) may be transmitted via computer network 120 to server(s) 102 for training of model(s) and/or generating output(s) based on the user-specific shave score as describe herein.

In some aspects, a shaving device (e.g., shaving device 150) may be communicatively coupled to a user computing device having a display screen. The display screen may output or render various data as described herein, including, for example a user-specific shave score. For example, user computing devices (e.g., user computing device 111c1 and user computing device 112cl) may include a display screen for displaying graphics, images, text, data, interfaces, graphic user interfaces (GUI), and/or such visualizations or information as described herein. For example, the display screen of a user computing device (e.g., user computing device 111c1) may display images, e.g., such as an output, to the user, via an application (app) executing on a user computing device (e.g., user computing device 111c1). The app may execute instructions, via a programming language, to receive the shave data and render it on a display screen of the user computing device. For example, an app may be implemented via one or more app programming languages including, for example, via SWIFT or Java for APPLE IOS and Google Android platforms, respectively. In various embodiments, a display or GUI indication may include one or more visualizations of data and/or score(s) based on the sensor data (e.g. load or pressure scores), data output (e.g., either raw data or processed data), user data, and/or graphs of the data (e.g., either raw data or processed data). Such display(s), GUI(s), or otherwise visualization(s) may be rendered or implemented via the app configured to execute on a user computer device (e.g., user computing device 111c1 as described herein). In such embodiments, the app may be configured to receive and render the shave data on a display screen of the user computing device (e.g., user computing device 111c1).

In some embodiments, the displayed data may be provided by the transceiver 158 and may be customizable by the user. For example, in various embodiments, the transceiver 158 is configured to provide an indication directly to the user (e.g., via an LED) or, additionally or alternatively, to another device (e.g., user computing device 111c1 as illustrated in FIG. 2 herein). The user may customize which, if any, of these ways the indication is provided.

In some aspects, the user-specific shave score may be stored in a memory (e.g., Memory 157) communicatively coupled to the one or more processors. Additionally, or alternatively, the user-specific shave score may be tracked by comparing the user-specific shave score to one or more of: other user-specific shave scores generated for the user (e.g., based on use of shaving device 150); and/or shave scores generated for other users (e.g., a user of second shaving device 170).

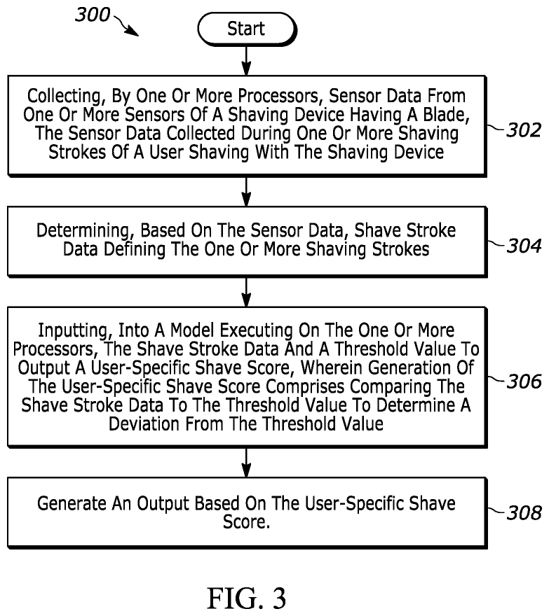

FIG. 3 illustrates a flowchart or algorithm of an example sensor-based method 300 of analyzing shaving performance in accordance with various embodiments disclosed herein. At block 302, sensor-based method 300 comprises collecting, by one or more processors, sensor data from one or more sensors of a shaving device (e.g., shaving device 150) having a blade.

In various aspects, the one or more processors may be a processor (e.g., processor 156) of the shaving device itself. Additionally, or alternatively, the one or more processor(s) may be those of one or more server(s) (e.g., processor(s) 104) in communication with a processor (e.g., processor 156) of the shaving device (e.g., shaving device 150).

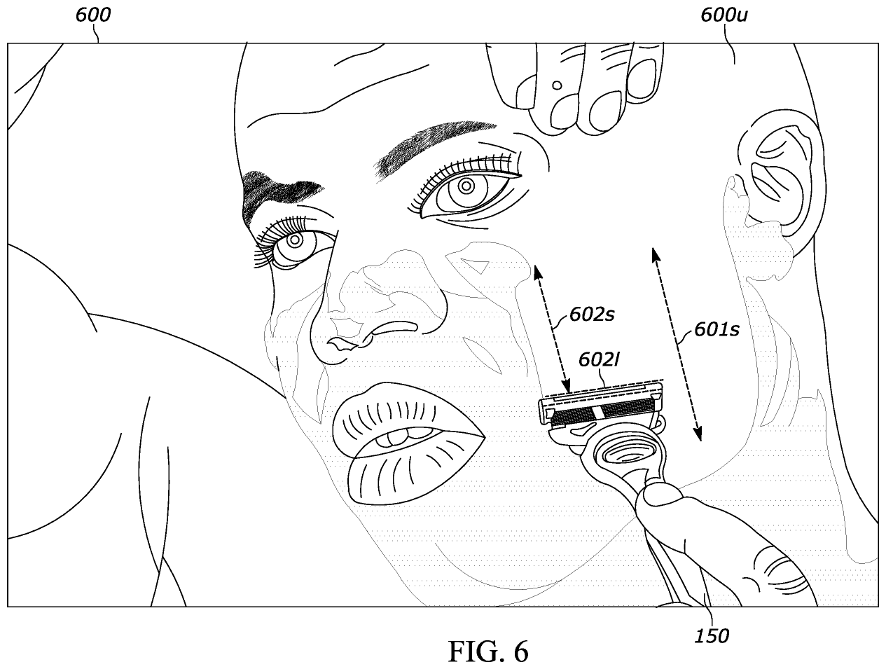

Still further, in the example of method 300, the sensor data is collected during one or more shaving strokes of a user shaving with the shaving device. For example, FIG. 6 illustrates an example user (e.g., user 600u) shaving with the shaving device (e.g., shaving device 150) as described for FIGS. 1 and 2 in accordance with various embodiments disclosed herein. In the example of FIG. 6, user 600u has made two shaving strokes (i.e., shaving stroke 601s and shaving stroke 602s) with shaving device 150. Sensor data is collected by sensor 154 as user 600u moves the razor across his skin. The sensor data may include location data, direction data, and pressure or load data, including for example, pressure or load data (e.g., load data 6021) at the point where the razor or otherwise cutting implement is applied the user's (e.g., user 600u) skin. The sensor data may be analyzed to determine the direction, path, and count of the users shaving strokes (e.g., shaving stroke 601s and shaving stroke 602s) for a given shaving session (e.g., a time period between the start and end of a shaving session).

At block 304, sensor-based method 300 comprises determining, based on the sensor data, shave stroke data defining the one or more shaving strokes. In various aspects, the shave stroke data may define a number of characteristics of the shaving device, including, by way of non-limiting example, the shaving device as applied to the user's skin, the user's behavior or usage of the shaving device, and/or other characteristics as described herein. For example, in some aspects, the shave stroke data may comprise a stroke pressure (e.g., pressure applied by the blade to the user's skin). The shave stroke data may further comprise a count of the one or more shaving strokes taken with the blade (e.g., number of strokes taken by the user for a given shaving session). The shave stroke data may further comprise a frequency of the one or more shaving strokes taken with the blade (e.g., number of strokes taken per given unit of time). The shave stroke data may further comprise a blade pivot angle (e.g., an angle of the blade relative to the user's skin), a rinse count (e.g., number of times the user rinsed), a rinse duration (e.g., how long a user rinsed), a water temperature (e.g., Fahrenheit or Celsius value of the water used when rinsing or shaving), and/or razor temperature (e.g., Fahrenheit or Celsius value of razor used when shaving).

Additionally, or alternatively, the shave stroke data may comprise a speed of the one or more shaving strokes taken with the blade (e.g., a speed that the shaving device as moved across the user's skin). Additionally, or alternatively, the shave stroke data may comprise a number of shaving sessions during a blade life of the blade (e.g., a number of times that the user has used a blade). Additionally, or alternatively, the shave stroke data may comprise an acceleration of the one or more shaving strokes taken with the blade (e.g., how fast or slow a user starts and/or stops the blade and/or shaving device for a given stroke). Additionally, or alternatively, the shave stroke data may comprise one or more stroke directions taken with the blade (e.g., an up stroke, a down stroke, a left stroke, a right stroke, and/or whether the stroke is against the grain of the user's hair or with the grain of the user's hair). A shave stroke direction may also comprise a direction based on degrees from a reference direction, such as vertically up. Additionally, or alternatively, the shave stroke data may comprise a stroke length (e.g., as measured in inches or centimeters).

Additionally, or alternatively, the shave stroke data may comprise stroke duration (e.g., the time it takes the user to complete a shaving stroke), stroke position (e.g., the location of a given stroke on the user's body), shave duration (e.g., the time it takes a user to complete a shave session, as defined from the beginning to the end of a complete shave), duration between shaves (e.g., the time between two shaving sessions), and/or duration between strokes (e.g., the time between two given strokes as taken by the user with the shaving device).

With further reference to FIG. 3, at block 306, sensor-based method 300 comprises inputting, into a model executing on the one or more processors, the shave stroke data and a threshold value, where the model is configured (e.g., trained) to output a user-specific shave score. Generation of the user-specific shave score may comprise comparing the shave stroke data, as described herein, to the threshold value to determine a deviation from the threshold value. Additionally, or alternatively, generation of the user-specific shave score may comprise inputting the threshold value, which may be specific to the user, to the model as input in order to determine a deviation from the threshold value.

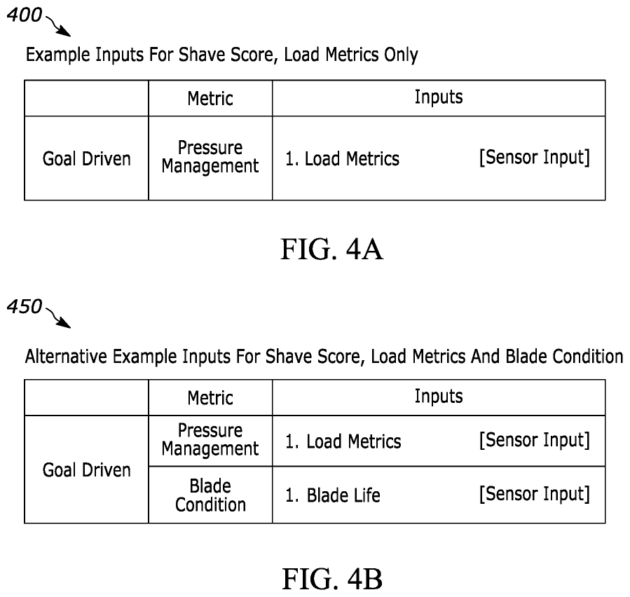

FIGS. 4A and 4B provides examples of simple models (e.g., which may comprise model 108) for determination or output of a user-specific shave score. In particular, FIG. 4A is a table defining example input(s) of a model for determination or output of a user-specific shave score in accordance with various embodiments disclosed herein. In the example of FIG. 4A, an example model uses load metrics determined from sensor data generated during one or more shaving strokes taken with the shaving device (e.g., shaving device 150). The load metrics define the pressure applied to the user skin. The pressure and/or the load metrics may be provided as input to the model to determine a user-specific shave score specific to the user's applied pressure and/or load metrics as detected for a given shaving session. In the example, of FIG. 4A, the user's shave score correlates with (e.g., is inversely proportional to) the load and/or pressure data across a 0-100 scale. Further, in the example of FIG. 4A, the model is configured as “goal driven” where the user-specific shave score is determined across a range of scores (e.g., having values 0-100 correlated to the load/pressure data), where the user is encouraged to apply, e.g., less pressure in order to achieve a higher user-specific shave score. In this way, the user-specific shave score can thereby enhance the user's shaving performance by allowing for reduced pressure thus resulting in less irritated skin following a shaving session.

FIG. 4B is a further table defining further example input(s) of a model for determination or output of a user-specific shave score in accordance with various embodiments disclosed herein. In the example of FIG. 4B, the same load metrics and pressure management are configured and applied as described for the model of FIG. 4A. However, the model of FIG. 4B further inputs an indication of blade life. In various aspects, blade life indicates an age of a blade (e.g., a cartridge of a razor). A determination of blade life could include a total number of strokes on cartridge, a total time of strokes on cartridge, a number of shaves on cartridge, a total load on cartridge, and/or a type of cartridge. Any of these values may either be input by a user or detected by a sensor (e.g., sensor 154) of shaving device 150. In addition, one or more of the metrics may be used to determine a blade condition, which is may be a value defining a condition, e.g., on a scale indicating the overall quality of the blade, e.g., at a given point in time. In such aspects, model 108, my take as input the load metrics, pressure data, blade life data, and/or blade condition data in order to output a user-specific shave score. In the example, of FIG. 4A, the user's shave score is correlated with (e.g., is inversely proportional to) the load and/or pressure data and the blade life across a 0-100 scale. Further, as for the model in FIG. 4A, the model of FIG. 4B may be “goal driven” in that the user-specific shave score is determined across a range of scores (e.g., having values 0-100 as determined from the load, pressure, and blade life data), where the user is encouraged to apply, e.g., less pressure and with a blade having a new blade life and/or better blade condition in order to achieve a higher user-specific shave score. In this way, the user-specific shave score can thereby enhance the user's shaving performance by allowing for reduced pressure, and new blade usage thus resulting in less irritated skin following a shaving session.

Additionally, or alternatively, a model (e.g., such as model 108) may comprise an artificial intelligence model, such as a machine learning model. In such aspects, the model may be trained, by one or more processors (e.g., processors 104) with sensor data, shave stroke data, pressure data, and/or other data as described herein, which may include user-specific sensor or shave stroke data determined during one or more shaving strokes of a plurality of respective users shaving with respective shaving devices (e.g., shaving device 150 and/or shaving device 170). Such training data may be received via computer network 120, for example, from a plurality of devices (e.g., shaving device 150 and/or shaving device 170) as used by respective users. The model may be trained to output a user-specific shave score for a new user (e.g., user 600u) based on data

For example, in various embodiments, a machine learning imaging model, as described herein (e.g. model 108), may be trained using a supervised or unsupervised machine learning program or algorithm. The machine learning program or algorithm may employ a neural network, which may be a deep learning neural network, or a combined learning module or program that learns in one or more features or feature datasets (e.g., sensor data, shave stroke data, pressure data, load data, blade life data, blade condition data, or any other data as described herein). The machine learning programs or algorithms may also include natural language processing, semantic analysis, automatic reasoning, regression analysis, support vector machine (SVM) analysis, decision tree analysis, random forest analysis, K-Nearest neighbor analysis, naïve Bayes analysis, clustering, reinforcement learning, and/or other machine learning algorithms and/or techniques. In some embodiments, the artificial intelligence and/or machine learning based algorithms may be included as a library or package executed on imaging server(s) 102. For example, libraries may include the TENSORFLOW based library, the PYTORCH library, and/or the SCIKIT-LEARN Python library.

Machine learning may involve identifying and recognizing patterns in existing data (such as training a model based on sensor data and/or shave stroke data of a user when shaving with a shaving device) in order to facilitate making predictions or identification for subsequent data (such as using the model to generate a user-specific shave score as described herein).

Machine learning model(s), such as a model 108 described herein for some embodiments, may be created and trained based upon example data (e.g., sensor data and/or shave data) as inputs or data (which may be termed “features” and “labels”) in order to make valid and reliable predictions when provided new inputs, such as testing level or production level data or inputs. In supervised machine learning, a machine learning program operating on a server, computing device, or otherwise processor(s), may be provided with example inputs (e.g., “features”) and their associated, or observed, outputs (e.g., “labels”) in order for the machine learning program or algorithm to determine or discover rules, relationships, patterns, or otherwise machine learning “models” that map such inputs (e.g., “features”) to the outputs (e.g., labels), for example, by determining and/or assigning weights or other metrics to the model across its various feature categories. Such rules, relationships, or otherwise models may then be provided subsequent inputs in order for the model, executing on the server, computing device, or otherwise processor(s), to predict, based on the discovered rules, relationships, or model, an expected output.

In unsupervised machine learning, the server, computing device, or otherwise processor(s), may be required to find its own structure in unlabeled example inputs, where, for example multiple training iterations are executed by the server, computing device, or otherwise processor(s) to train multiple generations of models until a satisfactory model, e.g., a model that provides sufficient prediction accuracy when given test level or production level data or inputs, is generated. The disclosures herein may use one or both of such supervised or unsupervised machine learning techniques.

For example, server(s) 102 may receive load data, pressure data, or other data as described herein, which may be used to train a sensor-based learning model (e.g., model 108) to generate a user-specific shave score. In some embodiments, the sensor-based learning model may be retrained upon an occurrence of a pre-determined trigger situation (e.g., such as elapsed amount of time, detection of first use, a new shaving session, and/or after an upgrade to the software of the shaving device). In some embodiments, the model 108 may be further trained with user profile data in combination with other data (e.g., load data or questionnaire data), where the user profile data adjusts the output of model 108 based on the user's responses or input as to the user profile data.

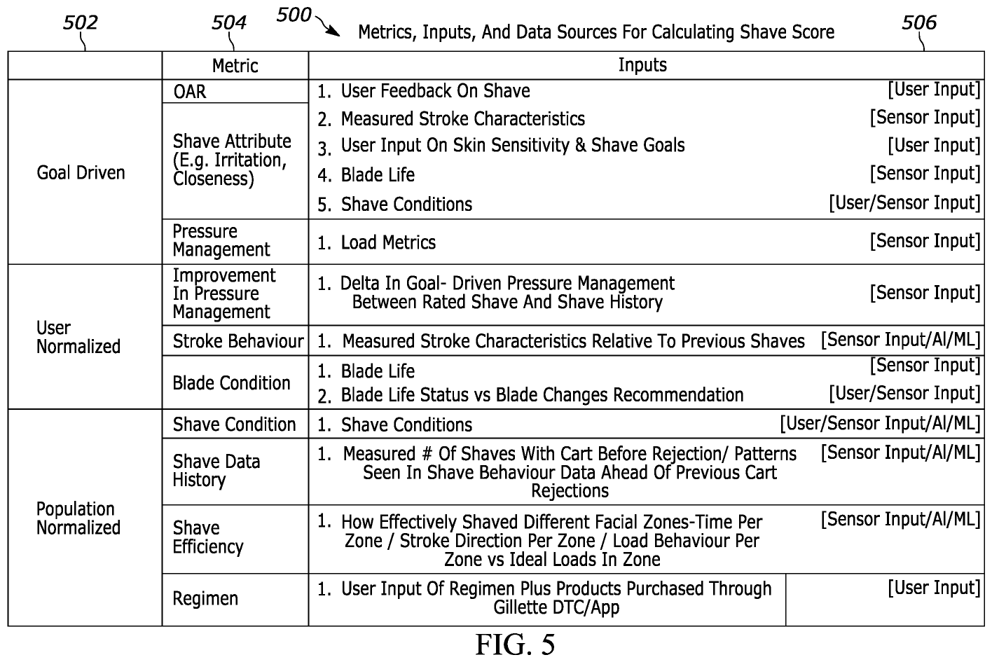

FIG. 5 is a table 500 defining example metrics, inputs, and data sources that may be used by a model (e.g., an artificial intelligence model, such as model 108 described for FIG. 1) for outputting a user-specific shave score in accordance with various embodiments disclosed herein. Model 108 may take as input and/or training data numerous data types, as exemplified by table 500, including sensor data (i.e., sensor input), user input, or other data as described herein. The model is trained and is configured to output a user-specific shave score based on the input and training data, respectively.

For example, as shown for FIG. 5, table 500 exemplifies various metrics, inputs, and data sources that could be used to calculate a user-specific shave score. Table 500 provides examples of these different metrics, inputs, and data sources based on the input data. Various different combination and/or permutations of the metrics, inputs, and data sources may be used as training data and/or input into model 108 in order to calculate or otherwise generate a user-specific shave score. Further, it is to be understood that additional or different data, other than shown in table 500, may be used to calculate a user-specific shave score as described herein.

In the example of FIG. 5, table 500 includes different types 502 of data defined across various metrics 504 each based upon one or more inputs 506. For example, Goal Driven types of data may define metrics (e.g., user feedback on shave, measured stroke characteristics, user input on skin sensitivity and/or shave goals, blade life, shave conditions, and/or shave attributes, such as irritation and closeness, and pressure management) configured for achieving a specific user goal. The goal may comprise, by way of non-limiting example, the reduction of skin irritation or closeness of shave. Such metrics may be based on sensor, shave stroke, and/or other data (e.g., user input or sensor-detected data) for determining the related metrics. These may include any one or more of user feedback on a shave, measured stroke characteristics, user input on skin sensitivity and shave goals, blade life, and/or shave conditions. In various aspects, shave conditions may comprise a location of a shave (e.g., sink versus shower, and/or home versus out of home), area of body being shaved (e.g., as calculated by motion sensors or user input), time of shave (e.g., weekday vs weekend, AM versus PM), a type of shave preparation, a duration of preparation on a user's face, water temperature (e.g., via a temperature sensor), and/or a number of rinses during shave.

As a further example as shown for table 500, User Normalized types of data may define metrics (e.g., improvement in pressure management, stroke behavior, blade condition) configured for normalizing a user's behavior to a baseline value known for desired shaving performance. Such metrics may be based on sensor or other data (e.g., user input or sensor-detected data) for determining the related metrics. These may include any one or more of a delta (e.g., a difference) in goal-drive pressure management between rated shave and shave history, measured stroke characteristics relative to previous shaves, blade life, and/or blade life compared to a blade change recommendation.

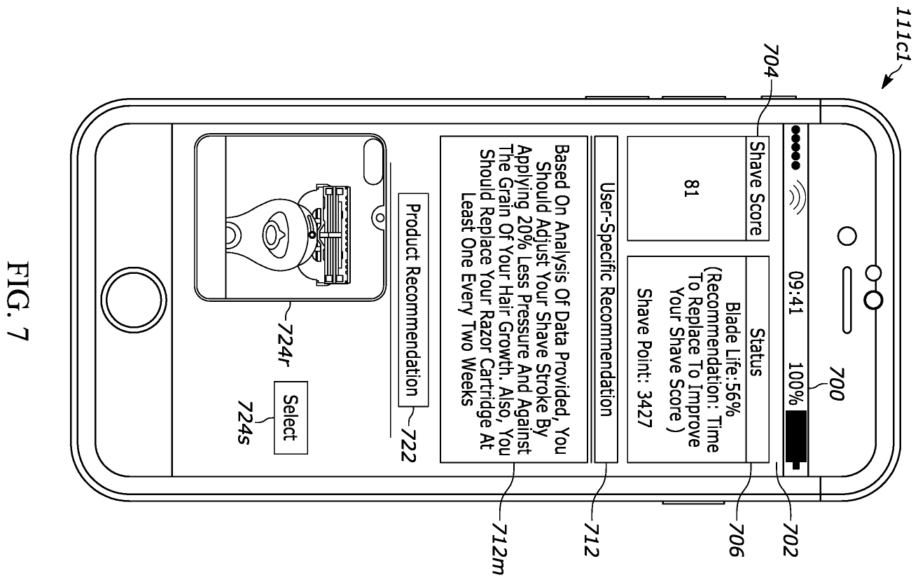

As a further example as shown for table 500, Population Normal types of data may define metrics (e.g., shave condition, shave data history, shave efficiency, and regimen) configured for normalizing a user's behavior to other that of other users (e.g., users that achieve high performance shaving). Such metrics may be based on sensor or other data (e.g., user input or sensor-detected data) for determining the related metrics. These may include any one or more of shave conditions (e.g., wet or dry), measured number of shaves with a cartridge before rejection by the user, patterns observed in shave behavior data ahead of previous cartridge rejection, measurements of shave efficiency for different facial zones (e.g., time per zone, stroke direction per zone, load behavior per zone, each of which may be compared to ideal loads in a facial zone). An input may further include a user regimen (e.g., a frequency) of purchasing products through an app, e.g., an app as described herein for FIG. 7.

It should be understood that the different types 502, metrics 504, and one or more inputs 506 are but examples, and that different, additional, or fewer inputs may be used to define different and/or additional metrics and goals for training a model (e.g., model 108).

In various aspects, a model (e.g., such as model 108) may be associated with a threshold value. For example, processor 156 and/or processor(s) 104 may compare the threshold value to its output. Additionally, or alternately, a threshold value may be provided as input for comparison and/or analysis. The threshold value may impact the output value of the user-specific shave score. In particular, the user-specific shave score may be based on one or more of: a quantity of the one or more user shaving strokes detected as having a value above or below the threshold value for the user. Additionally, or alternatively, the user-specific shave score may be based on a magnitude of the one or more user shaving strokes detected above or below a threshold deviation from the threshold value for the user. Still further, additionally, or alternatively, the user-specific shave score may be based on a time duration of the one or more user shaving strokes detected as having a value above or below the threshold value for the user.

In some aspects, the threshold value for the user may comprise one or more of a universal threshold value (e.g., a factory or default setting), a user selected threshold value (e.g., a high, medium, or low mode), and/or a unique threshold value for the user (e.g., as determined by via diagnostic shave of the user, which may determine a baseline threshold value specific to the user).

In some aspects user-specific data may be collected from the user. Such user-specific data may comprise one or more of one or more user inputs provided to a graphic user interface (GUI) via a form or questionnaire presented) and/or an initial dataset defining one or more initial shaving strokes of the user. In such aspects, the model may be configured by adjusting or updating the model with the user-specific data of the user. The value of the output of the user-specific shave score may then be adjusted based on the user-specific data of the user. For example, in such aspects, a user can manually adjust a unique threshold value up or down, e.g., based on their own personal preference or goals, by providing manual user input and/or baseline shaving data. For example, a baseline stroke behavior may be determined for a user based on an initial data set. A shave stroke deviation may then be determined for the user by comparing the baseline stroke behavior and the shave stroke data. A user-specific shave score may be based on the shave stroke deviation. For example, if a user has 200 strokes in a diagnostic shave but later needs 300 strokes due to cartridge wear (e.g., decreased blade quality), then this could identify shave stroke deviation. In another example, a number of strokes may be a first speed but may then decline to a second speed defining an increased tug and pull due to cartridge wear.

Additionally, or alternatively, a unique threshold value may be configured so to be adjustable by the user. Such embodiments allow the user to adjust the unique threshold value by adjusting different threshold percentage values or by setting different modes. For example, while a self-learning model (e.g., model 108), as described herein, may be used to set a unique threshold value, measuring load correctly for most users, a user may want to manually adjust their own unique threshold value up or down. In such embodiments, a user may select one or more modes (e.g. high mode, medium mode, and/or low mode) to adjust their threshold. The selection may be made, e.g., via a software application (app) executing on a user computing device (e.g., as shown and described for FIG. 7 herein).

Additionally, or alternatively, a user profile data may be acquired for the user e.g., via a software application (app) executing on a user computing device. This user profile data may then be used during the calculation of the unique threshold value to help determine the user's “mode” without the user having to explicitly select the mode manually. In such aspects, the threshold value is determined for the user by analyzing user input or device data comprising one or more of: a user rating of a shave event as reported by the user, a blade type, a cartridge type, a shaving preparation type, a style type, a style match result, and a hair type (e.g., course, fine, dense, thin, etc. Such data can be determined from can be from either user input, device settings, and/or other sensors (temperature sensors and/or hydrometers) of the shaving device (e.g., shaving device 150).

With further reference to FIG. 3, at block 308, sensor-based method 300 comprises generating an output based on the user-specific shave score. In some aspects, the output may comprise one or more visual indicia, such as, for example, one or more light emitting diodes (LEDs) on the shaving device (e.g., shaving device 150).

Other outputs may comprise activation of a component of the shaving device at particular times. For example, one or more of a motor, a visual indicator (e.g., LED), a tactile indicator, and/or an audible indicator of the shaving device may be activated when a high-load shaving stroke of the one or more shaving strokes is detected. In some aspects, a high-load shaving stroke may comprise pressure value above or below a threshold deviation from the threshold value.

FIG. 7 illustrates an example graphic user interface (GUI) 702 as rendered on a display screen 700 of a user computing device (e.g., user computing device 111c1) in accordance with various embodiments disclosed herein. For example, as shown in the example of FIG. 4, user interface 702 may be implemented or rendered via an application (app) executing on user computing device 111c1. As shown in the example of FIG. 7, user interface 702 may be implemented or rendered via a native app executing on user computing device 111c1. In the example of FIG. 7, user computing device 111c1 is a user computer device as described for FIG. 2, e.g., where user computing device 111c1 is illustrated as an APPLE iphone that implements the APPLE IOS operating system and has display screen 700. User computing device 111c1 may execute one or more native applications (apps) on its operating system. Such native apps may be implemented or coded (e.g., as computing instructions) in a computing language (e.g., SWIFT) executable by the user computing device operating system (e.g., APPLE IOS) by the processor of user computing device 111c1.

Additionally, or alternatively, user interface 702 may be implemented or rendered via a web interface, such as via a web browser application, e.g., Safari and/or Google Chrome app(s), or other such web browser or the like.

As shown in the example of FIG. 7, user interface 702 comprises an output, as generated by the algorithm or otherwise programming instructions described for method 300, of a user-specific shave score 704 and as rendered via GUI 702 on a display screen 700. User-specific shave score 704 shows a value of “81” which may be a value out of 100 for user 600u, reflecting that user 600u has a 81% shave performance compared to a baseline value and/or other users' (e.g., data as collected from shaving device 170, where user 600u uses shaving device 150). Such score may indicate a possibility for shaving performance improvement (e.g., closer to a value of 100 indicates ideal shaving performance). In various aspects, GUI 702 may provide a corresponding user-specific electronic recommendation 712 based on the user-specific shave score 704 having a message 712m informing the user exert less pressure.

In some aspects, GUI 702 may comprise status information. For example, status information 706 may comprise an output, as generated by the algorithm or otherwise programming instructions described for method 300, with an indication identifying an expected blade life (e.g., 56%) of the blade or cartridge based on the user-specific shave score 704. In various aspects, the expected blade life could be, or could define, the wear and tear a user can put on a blade before the user should change the blade (e.g., blade mileage). For example, one output, as generated by the algorithm or otherwise programming instructions described for method 300, could inform the user that the user has thirty shaves with the blade and that there is an expected five shaves remaining.

In some aspects, status information may include an output, as generated by the algorithm or otherwise programming instructions described for method 300, comprises a virtual reward based on the user-specific shave score. For example, as shown for FIG. 7 shave points, in the amount of 3427 points, are shown as a virtual reward earned by the user for, e.g., maintaining a shave score above a certain value and/or for using the app of GUI 702 for a given period of time. In some aspects, the virtual reward may be used as value or for a discount for a next purchase of a product related to shaving device 150.

In addition, the indication may comprise a further indication or otherwise recommendation to update or replace the blade based on the expected blade life. In various aspects, the further indication or recommendation may be based on the user-specific shave score, the number of strokes, duration of the shaving session, or other shave related data or input as described herein. In general, the expected blade life value may be used to determine when recommend replacing the blade, e.g., sooner if a user is determined to apply more pressure on the blade.

In some aspects, the user-specific electronic recommendation may comprise a product recommendation for a manufactured product based on the user-specific shave score and/or user-specific electronic recommendation 712. For example, GUI 702 may render a product recommendation 722 indicating that the user should purchase product 724r to satisfy the user-specific electronic recommendation 712. The user may select 724s to order or otherwise receive the product from the GUI.

In some aspects, an output, as generated by the algorithm or otherwise programming instructions described for method 300, may comprise initiating, based on an indication or otherwise the user-shave score other data provided herein, a replacement blade for shipment to the user.

Additionally, or alternatively, an output, as generated by the algorithm or otherwise programming instructions described for method 300, may comprise an electronic communication transmitted to a computing device (e.g., user computing device 111c1) providing information of a shipment of a new blade (e.g., product 724r) to the user (e.g., 600u). The indication may be transmitted to servers 102 of a manufacturer or otherwise provider of the product in order to initiate the shipment.

In various embodiments, the user-specific shave score 704, user-specific electronic recommendation 712, message 712m, status information 706, and/or product recommendation 722 may be transmitted via the computer network, from server(s) 102, to the user computing device of the user for rendering on the display screen of the user computing device. In such aspects, server(s) 102 may have received sensor data, shave stroke data, user data, and/or other data to generate or determine the various scores and/or recommendations, which may then be transmitted, via computer network 120, to shaving device 150 and/or user computing device 111c1.

In other embodiments, no transmission to the server(s) 102 occurs, where the user-specific shave score 704, user-specific electronic recommendation 712, message 712m, status information 706, and/or product recommendation 722 may instead be generated locally, by the model (e.g., 108) executing and/or implemented on the shaving device 150 and/or the user's mobile device (e.g., user computing device 111c1) and rendered, by a processor of the mobile device, on a display screen of the mobile device (e.g., user computing device 111c1), or otherwise output or provided as described herein.

### Aspects of the Disclosure

The following aspects are provided as examples in accordance with the disclosure herein and are not intended to limit the scope of the disclosure.

An aspect for a sensor-based method of analyzing shaving performance comprising: collecting, by one or more processors, sensor data from one or more sensors of a shaving device having a blade, the sensor data collected during one or more shaving strokes of a user shaving with the shaving device; determining, based on the sensor data, shave stroke data defining the one or more shaving strokes; inputting, into a model executing on the one or more processors, the shave stroke data and a threshold value to output a user-specific shave score, wherein generation of the user-specific shave score comprises comparing the shave stroke data to the threshold value to determine a deviation from the threshold value; and generating an output based on the user-specific shave score.

A further aspect includes the sensor-based method of the aspect above, wherein the shave stroke data comprises: a stroke pressure, a count of the one or more shaving strokes taken with the blade, and a frequency of the one or more shaving strokes taken with the blade.

A further aspect includes the sensor-based method of any one of aspects above, wherein the shave stroke data comprises one or more of: a stroke pressure, a count of the one or more shaving strokes taken with the blade, a frequency of the one or more shaving strokes taken with the blade, a speed of the one or more shaving strokes taken with the blade, a number of shaving sessions during a blade life of the blade, an acceleration of the one or more shaving strokes taken with the blade, one or more stroke directions taken with the blade, a stroke length, a blade pivot angle, a rinse count, a rinse duration, a water temperature, and a razor temperature.

A further aspect includes the sensor-based method of any one of aspects above, wherein the shave stroke data comprises one or more of: stroke duration, stroke position, shave duration, duration between shaves, and duration between strokes.

A further aspect includes the sensor-based method of any one of aspects above, wherein the threshold value for the user comprises one or more of: a universal threshold value, a user selected threshold value, and a unique threshold value for the user.

A further aspect includes the sensor-based method of any one of aspects above, wherein the threshold value is determined for the user by comprises analyzing user input or device data comprising one or more of: a user rating of a shave event as reported by the user, a blade type, a cartridge type, a shaving preparation type, a style type, a style match result, a hair type, and a duration between shaves.

A further aspect includes the sensor-based method of any one of aspects above, wherein the user-specific shave score is based on one or more of: a quantity of the one or more user shaving strokes detected as having a value above or below the threshold value for the user, a magnitude of the one or more user shaving strokes detected above or below a threshold deviation from the threshold value for the user, and a time duration of the one or more user shaving strokes detected as having a value above or below the threshold value for the user.

A further aspect includes the sensor-based method of any one of aspects above, wherein the output comprises one or more visual indicia.

A further aspect includes the sensor-based method of any one of aspects above, wherein the output comprises rendering the user-specific shave score via a graphic user interface (GUI) on a display screen.

A further aspect includes the sensor-based method of any one of aspects above further comprising: collecting user-specific data comprising at least one of: (a) one or more user inputs, or (b) an initial dataset defining one or more initial shaving strokes of the user; and configuring the model by adjusting or updating the model with the user-specific data of the user, wherein the output of the user-specific shave score is adjusted based on the user-specific data of the user.

The sensor-based method of any one of aspects above further comprising: generating, by the one or more processors, a user-specific electronic recommendation based on the user-specific shave score.

A further aspect includes the sensor-based method the aspect above further comprising: wherein the user-specific electronic recommendation comprises a product recommendation for a manufactured product.

A further aspect includes the sensor-based method of any one of aspects above further comprising: wherein the shaving device is communicatively coupled to a user computing device having a display screen, and wherein the sensor-based method further comprises rendering, by the one or more processors, the user-specific shave score on the display screen of the user computing device.

A further aspect includes the sensor-based method of any one of aspects above, wherein the output comprises an indication identifying an expected blade life of the blade based on the user-specific shave score.

A further aspect includes the sensor-based method of the aspect above, wherein the indication comprises an indication to update or replace the blade based on the expected blade life.

A further aspect includes the sensor-based method of the aspect above, wherein the output comprises initiating, based on the indication, a replacement blade for shipment to the user.

A further aspect includes the sensor-based method of any one of aspects above further comprising: activating one or more of: a motor, a visual indicator, a tactile indicator, or an audible indicator of the shaving device, when a high-load shaving stroke of the one or more shaving strokes is detected, wherein the high-load shaving stroke comprises a pressure value above or below a threshold deviation from the threshold value.

A further aspect includes the sensor-based method of any one of aspects above, wherein the model is an artificial intelligence model, and wherein the sensor-based method further comprises training, by the one or more processors, the model with respective user-specific pressure data and respective shave stroke data determined during one or more training shaving strokes of a plurality of respective users as the respective users shave with a respective shaving device, wherein the model is trained to output the user-specific shave score.

An aspect includes a sensor-based system configured to analyze shaving performance, the sensor-bases system comprising: a shaving device having a blade and comprising one or more sensors; one or more processors communicatively coupled to the shaving device; a memory communicatively coupled to the one or more processors; a model configured to execute on the one or more processors; and computing instructions stored on the memory and that, when executed by the one or more processors, cause the one or more processors to: collect sensor data from the one or more sensors of the shaving device, the sensor data collected during one or more shaving strokes of a user shaving with the shaving device; determine, based on the sensor data, shave stroke data defining the one or more shaving strokes; input, into the model, the shave stroke data and a threshold value to output a user-specific shave score, wherein generation of the user-specific shave score comprises comparing the shave stroke data to the threshold value to determine a deviation from the threshold value; and generate an output based on the user-specific shave score.

An aspect includes a non-transitory computer-readable medium storing computing instructions that when executed by one or more processors, cause the one or more processors to: collect sensor data from one or more sensors of a shaving device having a blade, the sensor data collected during one or more shaving strokes of a user shaving with the shaving device; determine, based on the sensor data, shave stroke data defining the one or more shaving strokes; input, into a model executing on the one or more processors, the shave stroke data and a threshold value to output a user-specific shave score, wherein generation of the user-specific shave score comprises comparing the shave stroke data to the threshold value to determine a deviation from the threshold value; and generate an output based on the user-specific shave score.

### Additional Aspects of the Disclosure

The following additional aspects are provided as examples in accordance with the disclosure herein and are not intended to limit the scope of the disclosure.

A further aspect includes the sensor-based method of any one of aspects above, wherein the output comprises an electronic communication transmitted to a computing device, the electronic communication providing information of a shipment of a new blade to the user.

A further aspect includes the sensor-based method of any one of aspects above further comprising: determining a baseline stroke behavior of the user based on the initial data set; and determining a shave stroke deviation by comparing the baseline stroke behavior and the shave stroke data, wherein the user-specific shave score is further based on the shave stroke deviation.

A further aspect includes the sensor-based method of any one of aspects above further comprising: storing the user-specific shave score in a memory communicatively coupled to the one or more processors; and tracking the user-specific shave score by comparing the user-specific shave score to one or more of: (a) other user-specific shave scores generated for the user; or (b) shave scores generated for other users.

A further aspect includes the sensor-based method of any one of aspects above, wherein the output comprises a virtual reward based on the user-specific shave score.

A further aspect includes the sensor-based method of any one of the aspects above, wherein one or more visual indicia comprises one or more light emitting diodes (LEDs) on the shaving device.

### Additional Considerations

Although the disclosure herein sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location, while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other embodiments, the one or more processors or processor-implemented modules may be distributed across a number of geographic locations.

This detailed description is to be construed as exemplary only and does not describe every possible embodiment, as describing every possible embodiment would be impractical, if not impossible. A person of ordinary skill in the art may implement numerous alternate embodiments, using either current technology or technology developed after the filing date of this application.

Those of ordinary skill in the art will recognize that a wide variety of modifications, alterations, and combinations can be made with respect to the above described embodiments without departing from the scope of the invention, and that such modifications, alterations, and combinations are to be viewed as being within the ambit of the inventive concept.

The patent claims at the end of this patent application are not intended to be construed under 35 U.S.C. § 112 (f) unless traditional means-plus-function language is expressly recited, such as “means for” or “step for” language being explicitly recited in the claim(s). The systems and methods described herein are directed to an improvement to computer functionality, and improve the functioning of conventional computers.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A sensor-based method of analyzing shaving performance comprising:
collecting, by one or more processors, sensor data from one or more sensors of a shaving device having a blade, the sensor data collected during one or more shaving strokes of a user shaving with the shaving device;
determining, based on the sensor data, shave stroke data defining the one or more shaving strokes;
inputting, into a model executing on the one or more processors, the shave stroke data and a threshold value to output a user-specific shave score, wherein generation of the user-specific shave score comprises comparing the shave stroke data to the threshold value to determine a deviation from the threshold value; and
generating an output based on the user-specific shave score.

2. The sensor-based method of claim 1, wherein the shave stroke data comprises: a stroke pressure, a count of the one or more shaving strokes taken with the blade, and a frequency of the one or more shaving strokes taken with the blade.

3. The sensor-based method of claim 1, wherein the shave stroke data comprises one or more of: a stroke pressure, a count of the one or more shaving strokes taken with the blade, a frequency of the one or more shaving strokes taken with the blade, a speed of the one or more shaving strokes taken with the blade, a number of shaving sessions during a blade life of the blade, an acceleration of the one or more shaving strokes taken with the blade, one or more stroke directions taken with the blade, a stroke length, a blade pivot angle, a rinse count, a rinse duration, a water temperature, and a razor temperature.

4. The sensor-based method of claim 1, wherein the shave stroke data comprises one or more of: stroke duration, stroke position, shave duration, duration between shaves, and duration between strokes.

5. The sensor-based method of claim 1, wherein the threshold value for the user comprises one or more of: a universal threshold value, a user selected threshold value, and a unique threshold value for the user.

6. The sensor-based method of claim 1, wherein the threshold value is determined for the user by analyzing user input or device data comprising one or more of: a user rating of a shave event as reported by the user, a blade type, a cartridge type, a shaving preparation type, a style type, a style match result, a hair type, and a duration between shaves.

7. The sensor-based method of claim 1, wherein the user-specific shave score is based on one or more of: a quantity of the one or more user shaving strokes detected as having a value above or below the threshold value for the user, a magnitude of the one or more user shaving strokes detected above or below a threshold deviation from the threshold value for the user, and a time duration of the one or more user shaving strokes detected as having a value above or below the threshold value for the user.

8. The sensor-based method of claim 1, wherein the output comprises one or more visual indicia.

9. The sensor-based method of claim 1, wherein the output comprises rendering the user-specific shave score via a graphic user interface (GUI) on a display screen.

10. The sensor-based method of claim 1 further comprising:
collecting user-specific data comprising at least one of: (a) one or more user inputs, or (b) an initial dataset defining one or more initial shaving strokes of the user; and
configuring the model by adjusting or updating the model with the user-specific data of the user,
wherein the output of the user-specific shave score is adjusted based on the user-specific data of the user.

11. The sensor-based method of claim 1 further comprising:
generating, by the one or more processors, a user-specific electronic recommendation based on the user-specific shave score.

12. The sensor-based method of claim 11 further comprising:
wherein the user-specific electronic recommendation comprises a product recommendation for a manufactured product.

13. The sensor-based method of claim 1 further comprising:
wherein the shaving device is communicatively coupled to a user computing device having a display screen,
and wherein the sensor-based method further comprises rendering, by the one or more processors, the user-specific shave score on the display screen of the user computing device.

14. The sensor-based method of claim 1, wherein the output comprises an indication identifying an expected blade life of the blade based on the user-specific shave score.

15. The sensor-based method of claim 14, wherein the indication comprises an indication to update or replace the blade based on the expected blade life.

16. The sensor-based method of claim 14, wherein the output comprises initiating, based on the indication, a replacement blade for shipment to the user.

17. The sensor-based method of claim 1 further comprising:
activating one or more of: a motor, a visual indicator, a tactile indicator, or an audible indicator of the shaving device, when a high-load shaving stroke of the one or more shaving strokes is detected,
wherein the high-load shaving stroke comprises a pressure value above or below a threshold deviation from the threshold value.

18. The sensor-based method of claim 1,
wherein the model is an artificial intelligence model, and
wherein the sensor-based method further comprises training, by the one or more processors, the model with respective user-specific pressure data and respective shave stroke data determined during one or more training shaving strokes of a plurality of respective users as the respective users shave with a respective shaving device,
wherein the model is trained to output the user-specific shave score.

19. A sensor-based system configured to analyze shaving performance, the sensor-bases system comprising:
a shaving device having a blade and comprising one or more sensors;
one or more processors communicatively coupled to the shaving device;
a memory communicatively coupled to the one or more processors;
a model configured to execute on the one or more processors; and
computing instructions stored on the memory and that, when executed by the one or more processors, cause the one or more processors to:
collect sensor data from the one or more sensors of the shaving device, the sensor data collected during one or more shaving strokes of a user shaving with the shaving device;
determine, based on the sensor data, shave stroke data defining the one or more shaving strokes;
input, into the model, the shave stroke data and a threshold value to output a user-specific shave score, wherein generation of the user-specific shave score comprises comparing the shave stroke data to the threshold value to determine a deviation from the threshold value; and
generate an output based on the user-specific shave score.

20. A non-transitory computer-readable medium storing computing instructions that when executed by one or more processors, cause the one or more processors to:
collect sensor data from one or more sensors of a shaving device having a blade, the sensor data collected during one or more shaving strokes of a user shaving with the shaving device;
determine, based on the sensor data, shave stroke data defining the one or more shaving strokes;
input, into a model executing on the one or more processors, the shave stroke data and a threshold value to output a user-specific shave score, wherein generation of the user-specific shave score comprises comparing the shave stroke data to the threshold value to determine a deviation from the threshold value; and
generate an output based on the user-specific shave score.
